(19) United States
(12) Patent Application Publication
(10) Pub. No.: US 2002/0042266 A1
(43) Pub. Date: Apr. 11, 2002

(54) System and methods for conserving wireless resources

(76) Inventors: Craig Heyward, Atlanta, GA (US); Jeff Thacher, Atlanta, GA (US); Michael DeKraker, Atlanta, GA (US)

Correspondence Address: MORRIS MANNING & MARTIN LLP, 1600 ATLANTA FINANCIAL CENTER, 3343 PEACHTREE ROAD, NE, ATLANTA, GA, 30326-1044, US

(21) Appl. No.: 09/974,019

(22) Filed: Oct. 10, 2001

Related U.S. Application Data
(60) Provisional application No. 60/239,436, filed on Oct. 10, 2000.

(51) Int. Cl. H04M 3/42

(52) U.S. Cl. 455/414; 455/450

(57) ABSTRACT

The intelligent mobile unit system is an all-in-one device that has the intelligence to determine if a new transmission of the current status is warranted based upon a change of status of the mobile unit since the last status transmission. Since the mobile unit has the intelligence to broadcast its status when necessary, a host system that receives the status updates knows the relevant current status at all times. Consequently, the host system can provide the mobile unit status to all inquiries without requesting an update from the mobile unit.

### CROSS REFERENCE TO RELATED APPLICATIONS

The following Patent Application claims priority to U.S. Provisional Application No. 60/239,436 filed on Oct. 10, 2000 entitled “System & Method for Wireless Tracking.” The U.S. Provisional Application number 60/239,436 entitled “System & Method for Wireless Tracking” is incorporated by reference in its entirety.

### TECHNICAL FIELD

The invention relates generally to the field of wireless network-based services and, more particularly, to a system and methods that intelligently determines transmissions in order to conserve wireless resources.

### BACKGROUND OF THE INVENTION

Along with the Internet popularity explosion, wireless applications have also dramatically proliferated. The growth in demand for these wireless services places a heavy load on the current wireless networks. Technical and economic restraints limit the amount of data that can readily be transmitted via these networks. Wireless devices represent the ultimate constrained devices with limited CPU, memory, and battery life. Wireless networks are constrained by low bandwidth, high latency, and unpredictable availability and stability. Driven by the rapid evolution in positioning technologies, wireless subscribers desire instant, localized, personalized and accurate data despite any technological restraints. Consequently, it is imperative to engineer the most efficient utilization of these resources to provide a commercially successful wireless application.

Integration of Global Positioning System technology, wireless communications and the Internet enable the efficient management of mobile resources with location-relevant and time-sensitive information. The Global Positioning System is a world wide navigation system formed from a constellation of satellites that are used as reference points to calculate current positions. The complex task of monitoring and tracking the movement of products and people is critical to any company seeking to minimize resource requirements while maximizing profitability.

However, provision of the data required for the monitoring and tracking of movements can tax the abilities of the available resources of both wireless network and the wireless monitoring unit. The battery life of a monitoring unit is dramatically reduced by frequent radio broadcasts. Therefore, a conflict exists between conservation of battery power and the provision of accurate data. Likewise, frequent utilization of the wireless networks for constant updates can be extremely expensive.

What is needed is an intelligent monitoring unit that can be programmed to report only when desired. The unit needs to be able to broadcast status less frequently if battery life is an issue. The user should be able to define when the unit should broadcast its current status. Consequently, the unit should have intelligence such that it reports only when required. This intelligence will enable a host system to always know the relevant current status of the mobile unit. Therefore, the host system will be able to provide the current status without requesting this information from the mobile unit.

The unit should not report if its status has not changed. If the unit has not changed position, a new position status is unnecessary. Furthermore, a user may only desire to know if a unit has entered or left certain predefined zones. A user may desire to instantly know if an alert has occurred, such as the unit moving during off-hours, traveling outside of an established area, or is speeding above a predetermined setpoint. The unit needs to be intelligent to determine if the current conditions require a status update or not. Reporting only when preset conditions are satisfied can greatly reduce the number of unnecessary transmissions.

In addition, the monitoring unit should be to be physically small in size so that the unit is aesthetically pleasing as well as hard to steal because the unit can be easily concealed. Moreover, consumers desire a unit that requires no assembly. Therefore, a monitoring unit should be self contained as well as intelligent.

### SUMMARY OF THE INVENTION

The present invention meets the needs described above in an intelligent mobile unit system. The mobile unit is an all-in-one device that has the intelligence to determine if a new transmission of the current status is warranted based upon a change of status of the mobile unit since the last status transmission. Since the mobile unit has the intelligence to broadcast its status when necessary, a host system that receives the status updates knows the relevant current status at all times. Consequently, the host system can provide the mobile unit status to all inquiries without requesting an update from the mobile unit. Because the intelligent mobile unit only transmits a status report upon a predetermined change of status, the unit makes better use of the wireless network. For example, location information is not needed to be transmitted when the unit is not moving. In addition, because the host system knows the relevant current status, the host system does not have to make repeated inquiries to the mobile unit for each new status request to provide the current status.

Generally described, the invention is an intelligent mobile unit system. The intelligent mobile unit can compare the current status data with the last broadcast status data. The unit can determine if a new transmission is warranted based upon a broadcast status criteria wherein the broadcast status criteria includes a plurality of predetermined criterions. Such criteria include the power from an external power source, the change in status of an external sensor, entering or exiting a predetermined geographic zone, a triggered alarm, or other predetermined criteria. Alarms can include exceeding a predetermined speed limit, exiting a geographically defined zone, or movement during a predetermined time period such as weekends. If the broadcast status predefined criteria has been satisfied, the intelligent mobile unit transmits the current status data.

A host system receives the current status data from a mobile unit through a wireless network and stores the current status data. When the host system receives a request for the current status of the mobile unit from a user, the host system can retrieve the current status data from its own storage rather than waiting for a status request response from the mobile unit. Consequently, the host system can provide the status information quickly and efficiently to numerous different users. Provision of information in this manner minimizes transmissions and power usage of the unit.

The intelligent mobile unit may be an all-in-one device. In this embodiment, the container includes connectors for an external power source and external sensor signals. The unit also includes an internal power supply chargeable by an external power source, an internal global positioning receiver, an internal processor, internal memory, an internal radio modem, and an internal antenna.

A wireless network receives wireless data packets transmitted from the radio modem within the mobile unit. The wireless network delivers the data packets containing status information to a host system. The host system stores the data packet information. Requests for the current status of a mobile unit is received by the host system via a global computer network. The host system retrieves the status information from the storage mechanism and delivers the requested information via the global computer network.

Consequently, the intelligent mobile unit system can provide current status information to users with an all-in-one device while conserving wireless resources.

### BRIEF DESCRIPTION OF THE DRAWINGS

Benefits and further features of the present invention will be apparent from a detailed description of preferred embodiment thereof taken in conjunction with the following drawings, wherein like elements are referred to with like reference numbers, and wherein:

FIG. 1 is a functional block diagram of the present invention illustrating an overview of the wireless application service provider environment.

FIG. 2 is a functional block diagram illustrating a mobile unit.

FIG. 3 is a functional block diagram illustrating a limited broadcasting criteria.

FIG. 4 is a functional block diagram illustrating battery power conservation.

FIG. 5 is a functional block diagram illustrating a WASP hardware architecture.

FIG. 6 is a functional block diagram illustrating basic message formats.

FIG. 7 is a logic flow diagram illustrating a power conservation routine.

FIG. 8 is a logic flow diagram illustrating an intelligent broadcast routine .

FIG. 9 is a logic flow diagram illustrating a mobile unit tracking routine.

FIG. 10 is a screen shot from a web page illustrating a status report.

FIG. 11 is a screen shot from a web page illustrating a history report.

FIG. 12 is a screen shot from a web page illustrating an edit zone page.

### DETAILED DESCRIPTION OF THE EMBODIMENTS

The described embodiments disclose an efficient utilization of wireless resources while enabling the provision of the information received from the wireless network to a global computer network. As wireless applications dramatically increase, the demands placed on the wireless networks and related resources correspondingly escalates. These applications include the integration of Global Positioning System technology, wireless communications and the Internet to manage mobile resources with location relevant and time sensitive information. The applications have the ability to provide instantaneous status information. However, the desire for an abundance of current information often competes with efficient utilization of the available resources. Accordingly, the described embodiments illustrate improved management of resources while fulfilling the need for current status information.

A diverse user base may desire to know the current location of a multitude of mobile units. Constant queries to a plethora of mobile units for a current status report could possibly tax the wireless network capabilities. Furthermore, the net result of such queries could be quite expensive. However, intelligence programmed into a mobile unit could result in the mobile unit reporting its location only upon a predetermined criteria. Consequently, the last reported status has sufficient accuracy such that the mobile unit would not have to be queried to report the current status. For example, during some time periods, the location of a unit being tracked does not change. During these instances, it is not necessary to broadcast the new current location since no position changes have occurred. It is not efficient to broadcast on a frequent basis the position of non-moving objects. Therefore, the last reported status would be sufficient to accurately provide the unit's current status. Accordingly, the current status can be obtained from the last stored status report rather than by querying the mobile unit. As a consequence of providing the status from stored information on a server, the wireless network usage is minimized and multiple users can obtain the identical information much more rapidly than having to wait on one or more separate unit query results.

In addition, broadcasting a status report uses precious battery reserve of the unit. Limiting the broadcasting conserves power. Additionally, when no external power is available, the unit can be programmed to report less frequently. Conversely, frequent status reports can be made when an external power source is connected to the mobile unit.

Furthermore, the mobile device can be designed to be an all-inclusive unit. The unit can contain an internal antenna, power source, GPS receiver, radio modem, as well as a processor and memory. Having all the functional components in an all-in-one box allows for easy installation or transportation. In addition, an all-in-one unit can be readily hidden to prevent theft and as a consequence has no detriment associated aesthetics.

Thus, the embodiments describe improvements on the integration of Global Positioning System technology, wireless communications and the Internet to manage mobile resources with location relevant and time sensitive information. However, the invention is not to be limited to the specific terminology selected, and it is to be understood that each element includes all technical equivalents which operate in a similar manner to accomplish the disclosed results.

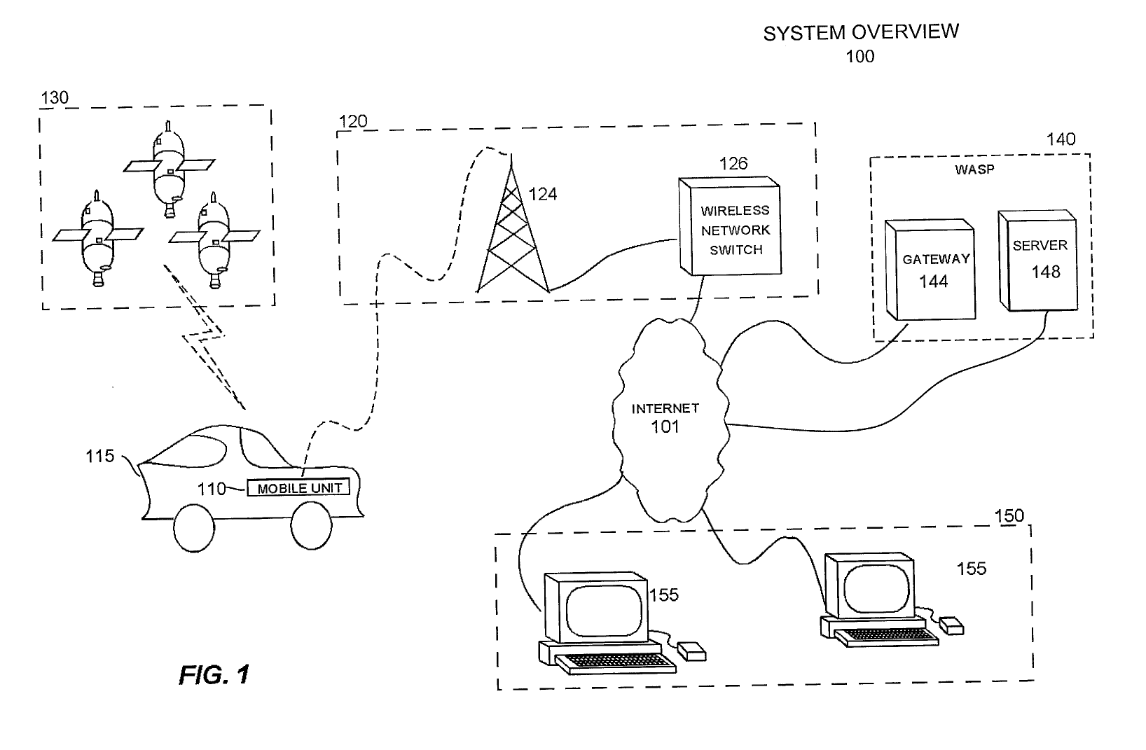

Turning to the figures, in which like numerals indicate like elements throughout the several figures, FIG. 1 illustrates an overview of the wireless application service provider (WASP) system 100 constructed in accordance with an embodiment of the present invention. The system 100 is connected for computer communications via a known global computer network commonly known as the Internet 101. It is known in the art to send packets of information via the Internet. One common known protocol for the transfer of data is the User Datagram Protocol (UDP), which is used to communicate with a wireless network 120. UDP is a communication protocol in a network that uses the Internet Protocol (IP). Another common protocol for the transfer of data via the Internet 101 is the Transfer Control Protocol/Internet Protocol (TCP/IP), which is used to communicate a plurality of system users 150. Additionally, it is known in the art to send data packets over a wireless network 120 such as the MOBITEX network.

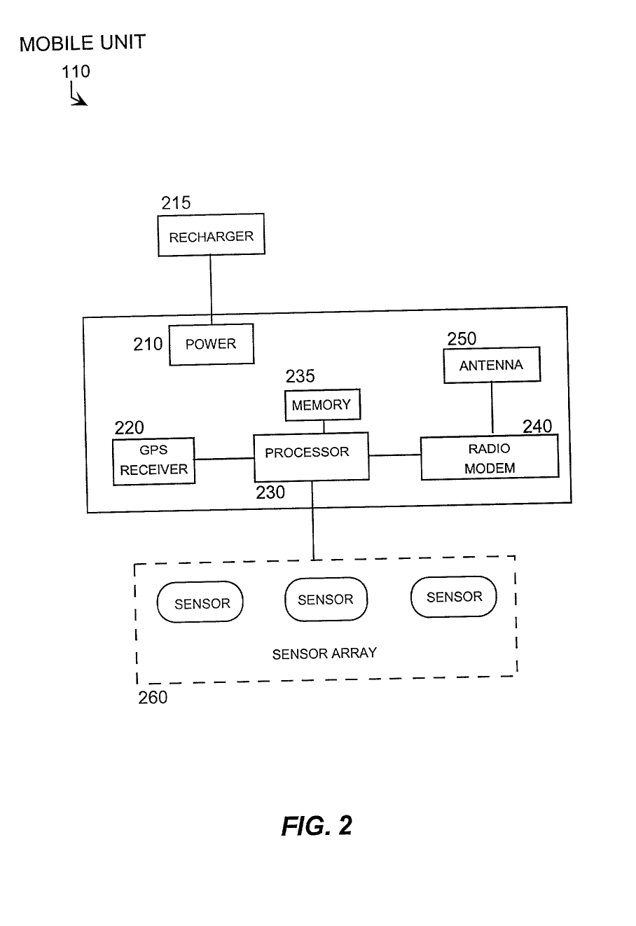

The WASP system 100 provides mobile data information management. The system 100 monitors and tracks the location of mobile units 110 associated with a vehicle 115 or other moving objects. The mobile unit 110 is an all-in-one box that includes an internal antenna, power source, GPS receiver, radio modem, as well as a processor and memory. The processor and memory enables the mobile unit 110 to possess the intelligence needed to optimize network and battery usage. The mobile unit 110 is described in greater detail in reference to FIG. 2.

A geostationary orbiting satellite positioning system 130 provides signals for a receiver within the mobile unit 110 to accurately determine its current position. The operation of positioning systems 130 is well known in the art and include such as the Global Positioning System (GPS) or the Russian Glonass system. The GPS is a constellation of 24 well-spaced satellites that orbit the Earth at 10,600 miles above the earth. The satellites are so spaced that from any point on Earth, four satellites will be above the horizon. Each satellite contains a computer, an atomic clock, and a radio. Each satellite continually broadcasts its changing position and time. With this information, any ground receiver can triangulate its position with accuracy.

The mobile unit 110 also includes a radio modem capable to receiving request and transmitting location and other data to a wireless data network 120. Wireless data networks 120 are well known in the art. One such wireless data network 120 is the MOBITEX network. MOBITEX is a packet-switched, narrow band network designed for wide-area wireless communications. In a MOBITEX network, a base station 124 operates at 900 megahertz in the United States and provides coverage for a cell area. A switch 126 controls communication routes to and from base stations 124 and between wireless devices 110 and fixed terminals 128. The switches also provide the gateway function to other networks 101.

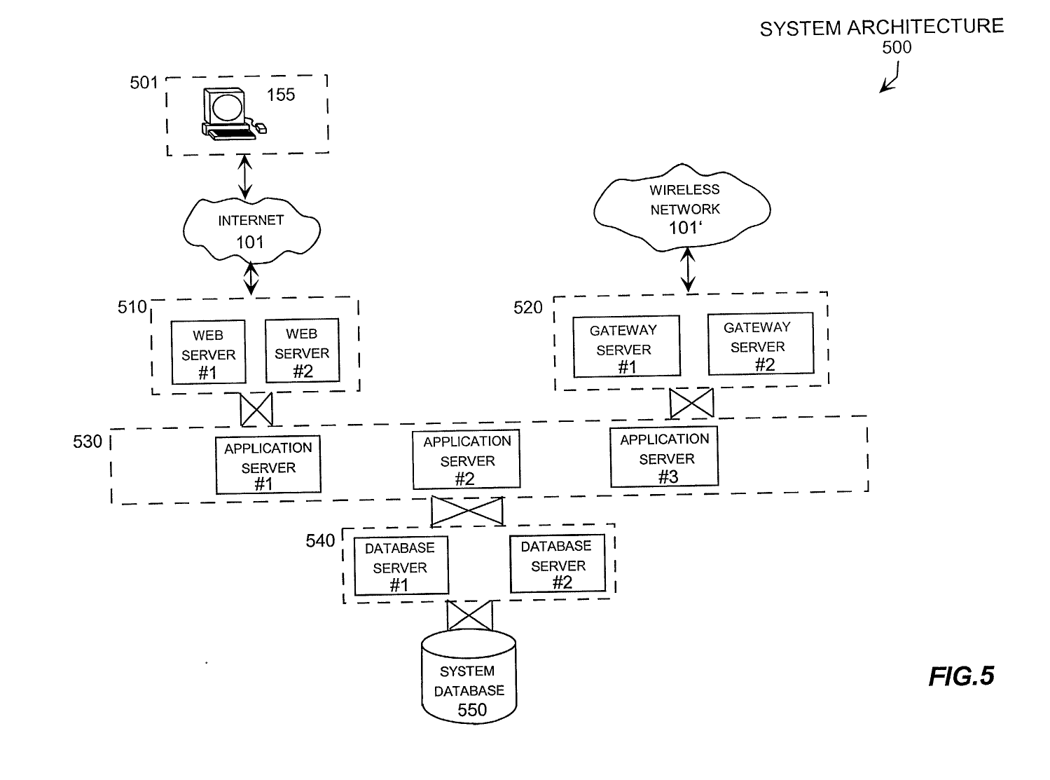

The wireless application service provider (WASP) 140 provides the users 150 with current status of a mobile unit 110. The WASP 140 has a host server that communicates via the Internet 101 with a client computer systems 155. Multiple client systems 155′ can access the WASP 140 and receive the identical information because the current status does not need to be determined by a request to the mobile unit 110. A gateway 144 in the WASP 140 handles the packets received from and transmits packets to the wireless network 120. The hardware architecture of the WASP 140 is described in greater detail in reference to FIG. 5.

FIG. 2 and the subsequent figures provide illustrations for a discussion of a series of message formats, data structure diagrams, hardware and software architectures, process diagrams in the form of flow charts, and user interface screen shots that illustrate an exemplary embodiment of a system and corresponding methods for the disclosed wireless application service provider system 100.

FIG. 5 discloses a logical hardware architecture of the WASP 140 constructed in accordance with an embodiment of the present invention. As will be understood in the art, the system is constructed utilizing Internet-enabled computer systems with computer programs designed to carry out the functions described herein. Although the disclosed embodiments are generally described in reference to Internet-accessible computers, those skilled in the art will recognize that the present invention can be implemented in conjunction with other program modules for other types of computers.

The disclosed embodiment of the present invention is implemented in a distributed computing environment such as the Internet 101. In a distributed computer environment, program modules may be physically located in different local and remote memory storage devices. Execution of the program modules may occur locally in a stand-alone manner or remotely in a client/server manner. By way of illustration and not limitation, distributed computing environments include local area networks (LAN) of an office, enterprise-wide area networks (WAN), and the global Internet (wired or wireless connections). Accordingly, it will be understood that the terms computer, operating system, and application program include all types of computers and the program modules designed to be implemented by the computers.

The discussion of methods that follows, especially in the flow charts, is represented largely in terms of processes and symbolic representations of operations by conventional computer components, including a central processing unit (CPU), memory storage devices for the CPU, connected display devices, and input devices.

The processes and operations performed by the computer include the manipulation of signals by a CPU, or remote server such as an Internet web site, and the maintenance of these signals within data structures reside in one or more of the local or remote memory storage devices. Such data structures impose a physical organization upon the collection of data stored within a memory storage device and represent specific electrical, optical, or magnetic elements. These symbolic representations are one way by which those skilled in the art of computer programming and computer construction communicate to effectively disclose the teachings and discoveries to others skilled in the art.

For the purposes of this discussion, a process is understood to include a sequence of computer-executed steps leading to a concrete, useful, and tangible result, namely, the provision of the status of the mobile unit 110 to the user 150.

These steps generally require manipulations of quantities such as available longitude, latitude, date, time, signal strength, speed, heading and other data. Usually, though not necessarily, these quantities take the form of electrical, magnetic, or optical signals capable of being stored, transferred, combined, compared, or otherwise manipulated. It is conventional for those skilled in the art to refer to these signals as bits, bytes, words, values, elements, symbols, characters, terms, numbers, points, records, objects, images, files or the like. It should be kept in mind, however, that these and similar terms should be associated with appropriate quantities for computer operations, and that these terms are merely conventional labels applied to quantities that exist within and during operation of the computer.

It should also be understood that manipulations within the computer are often referred to in terms such as displaying, deciding, storing, adding, comparing, moving, positioning, placing, and altering which are often associated with manual operations performed by a human operator. The operations described herein include machine operations performed in conjunction with various input provided by a human operator or user that interacts with the computer. In addition, it will be understood that the programs, processes, routines and methods described herein are not related or limited to any particular computer or apparatus, nor are they related or limited to any particular communication network architecture. Rather, various types of general-purpose machines may be used with program modules constructed in accordance with the teachings described herein. Similarly, it may prove advantageous to construct a specialized apparatus to perform the method steps described herein by way of dedicated computer systems in a specific network architecture with hard-wired logic or programs stored in nonvolatile memory, such as read only memory.

With the foregoing in mind, the drawing figures illustrate various functions, processes, or routines carried out by an embodiment of the present invention in which the system 100 carries out the functions described in connection with the flow charts and database maintenance. The functions or processes in these figures are carried out in the disclosed embodiment of the present invention by software executing in computers associated with WASP 140, the users 150, and/or the mobile unit 110. Depending upon the particular operation, the computers are connected for data communications via a network such as the Internet 101 or for communications via a wireless communication network 120 such as MOBITEX. It will also be understood that the processes and methods presented here may be arranged differently, or steps taken in a different order. In other words, some processes and methods may be deleted, repeated, re-ordered, combined, or blended to form similar processes and methods.

FIG. 2 illustrates one embodiment of the hardware for a mobile unit 110. The mobile unit 110 is an all-in-one self-contained box that includes data connector and an external power connector. Having all the functional components in an all-in-one box allows for rapid installation. The box is small and lightweight, weighing approximately one pound, for easy transportation. The current dimension of the all-in-one unit 110 is 4 inches by 3 inches and a depth of 1.385 inches. In addition, the all-in-one unit can be readily hidden to prevent theft and as a consequence has little associated aesthetic detriments.

The mobile unit 110 includes a device for obtaining a geographical position 210 such as a commercially available GPS receiver, a Glonass system receiver, or a Loran-C system receiver. Geographical position is obtained by querying an integrated module such as the GPS module produced by Trimble Information Services, Inc. In addition, the unit 110 includes a commercially available internal power source 210 and a connector for charging by an external power source or recharger 215. Once power is applied to the mobile unit 110, it will initialize and determine its current status. The radio modem 240 such as a RIM 902M radio transmits status information to a wireless network 120. Additionally, the unit 110 contains an internal antenna 250 preferably a 900 MHZ MOBITEX antenna. The mobile unit also includes an embedded processor 230 such as an Intel 80386 and associated memory 235. The use of a processor 230 and memory 235 in portable devices is well known in the art. The processor 230 queries any attached sensor array 260. The sensors 260 are any serial connected sensors that can communicate to the embedded process 230 using a protocol such as RS232, Ic2, or other discrete digital inputs. These sensors 260 may include motion, load, temperature, voltage, or any other sensed data.

On a regular basis the processor 230 determines if a transmission of data is necessary. Optimization of transmissions limit power consumption and radio usage from the unit 110. Based on a stored profile in the memory 235, transmission of data may only occur when it has been determined some sensor state or value has been attained or some change in geographical position has occurred. Transmission may also occur on a predetermined regular time basis. Transmission can be achieved by a data capable radio 240 (such as RIM 902M ) and transmission can include any relevant information including geographical position, speed, time of fix and any sensor data. Should no radio coverage or a network outage exist, this transmission may be stored in memory 235 for re-transmission when radio coverage becomes available. A profile stored on the mobile unit 110 may be altered via remote command to alter the values stored. Values such as report interval, sensor thresholds and switches determining actions may be altered. As known in the art, this data may be compressed utilizing a method such as bit stealing, arithmetic, Huffman, or in some manner to minimize radio transmission size. Should external power be available, for example for a solar panel, freight train power chassis, or a car battery, this power is applied to charge the internal power store.

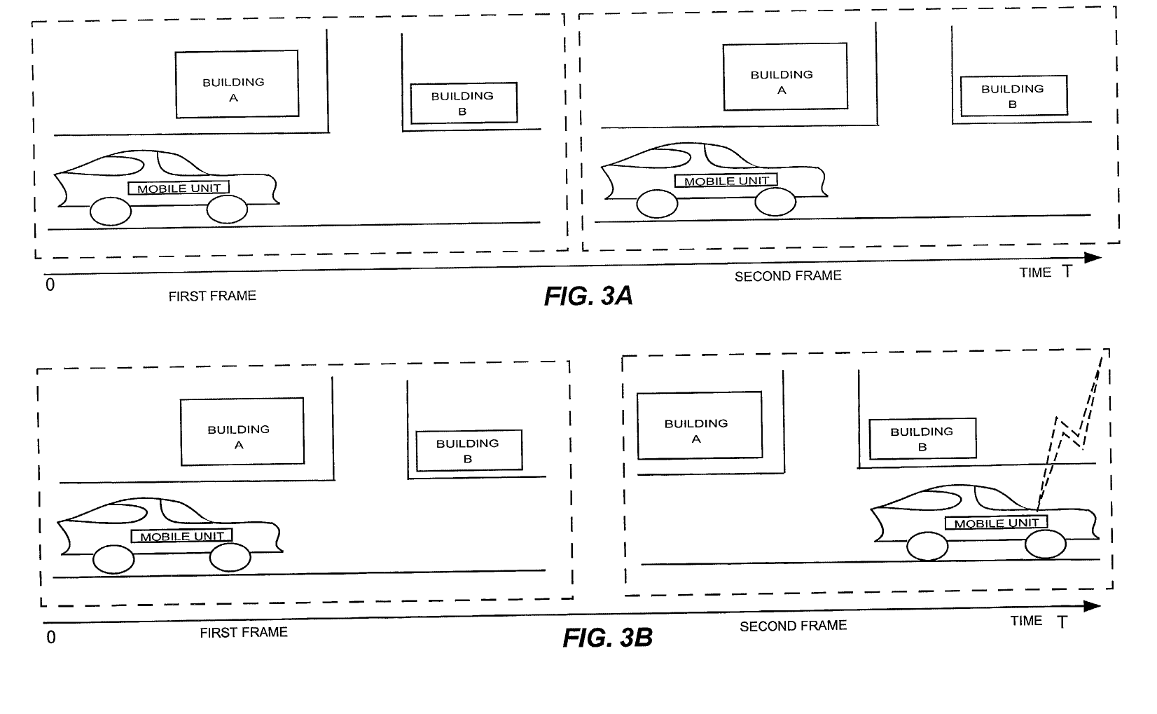

FIG. 3 illustrates one logic criteria for transmission of new current status from a mobile unit 110. As illustrated in FIG. 3A, the mobile unit 110 has not changed location from time 0 shown in the first frame and time T depicted in the second frame. The process 230 can determine from either GPS information or from the sensor array 260 that no status change has occurred. Therefore, the process 230 determines that no new transmission of current status should occur from the mobile unit 110.

As illustrated in FIG. 3B, the mobile unit 110 has changed location from time 0 shown in the first frame and time T depicted in the second frame. The process 230 therefore determines from either GPS information or from the sensor array 260 that a status change has occurred. The process determines is the change meets a predetermined-stored criteria for the amount of change required for a new status report. In the example, the process 230 determines that a new transmission of current status should occur and causes a reporting of the new status. This criteria for reporting can be changed by a message sent to the mobile unit 110.

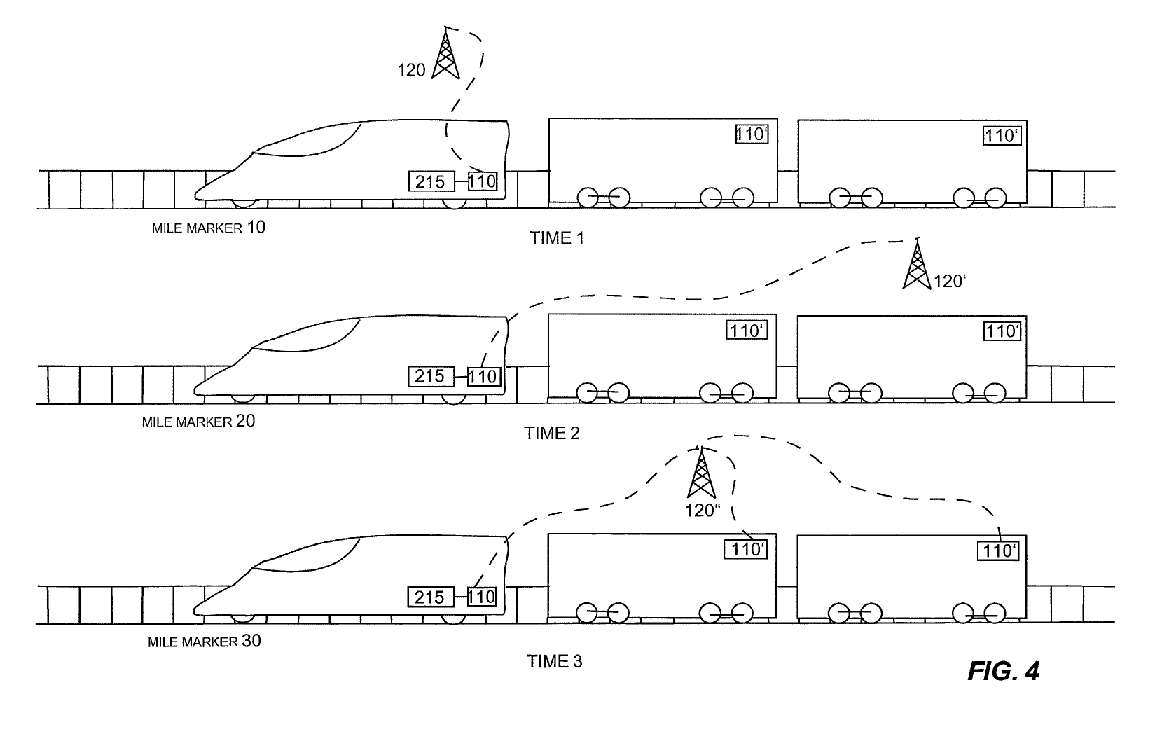

FIG. 4 illustrates another logic criteria for transmission of new current status from a mobile unit 110. As illustrated in time 1, the processor in the mobile unit 10 that is connected to an external power source 215 has determined that a transmission of a new status report is merited. However, the mobile units 110′ that are not connected to an external power source have not met the criteria for a new transmission.

Likewise, as illustrated in time 2, the processor in the mobile unit 110 that is connected to an external power source 215 has determined that a change of location was sufficient to warrant transmission of a new status report. However, the mobile units 110′ that are not connected to an external power source still have not met the criteria for a new transmission.

However, as illustrated in time 3, the processor in the mobile unit 110 that is connected to an external power source 215 again has determined that a change of location was sufficient to warrant transmission of a new status report. Now however, the mobile units 110′ that are not connected to an external power source have met the criteria for a new transmission. Therefore, these mobile units 110 transmit their current status via the wireless network 120. As illustrated, the mobile units not connected to external power sources are programmed to report less frequently or require a greater location change from the previous transmission.

FIG. 5 illustrates an embodiment of a system hardware architecture 500 of WASP 140 constructed in accordance with the invention. The disclosed embodiment utilizes a tiered application architecture to distribute different application components over different servers. Please note that other embodiments of the present invention may combine certain application components onto the same server.

At a client tier 501, at which users interface with the WASP 140, consists of client legacy computers 155 running a web browser or other client application that retrieves and displays the system's web pages. The client legacy computers 155 retrieve these web pages over a network tier, which is a telecommunication network such as the Internet 101.

Internet communications with the WASP 140 are effected by an Internet front end typically including a router, a load balancer, and a firewall. The router is operative in the known manner to send and receive data packets, typically in the form of TCP/IP packets commonly used for Internet communications. The load balancer operates in a known manner to balance the load from various communications amongst a plurality of computers or servers that are employed to construct the WASP 140. The data packets pass through a firewall, which ensures the overall security in a known manner before being passed to a plurality of web servers 510.

The web servers 510 include a plurality of redundant similarly configured computers, two of which are illustrated, that are operative to implement the front-end software. The web servers 510 are operative to receive requests and display information to users operating a web browser. The web servers 510 are coupled to a block of application servers 530.

The application servers 530 include a plurality of redundant similarly configured servers, three of which are illustrated, that are operative to implement the application software. The application servers 530 are operative to implement logic software utilized by the WASP 140. The application servers 530 are coupled to the web servers 510, a plurality of gateway servers 520, and a plurality of database servers 540.

The database servers 540 include a plurality of redundant similarly configured servers, two of which are illustrated, that are operative to store and retrieve information from a database 550. Data storage can be accomplished by databases or flat files. For example, the location history is stored in a flat file according to the Julian day and year in a separate area per subscriber. Contained in each file is a space-delimited record for each position fixed received. The record includes the time, latitude, longitude, speed, heading, and flags. The database servers are coupled to the application servers 530.

The gateway servers 520 include a plurality of redundant similarly configured servers, two of which are illustrated, that are operative to provide communications with wireless network 120.

Once a packet enters the Gateway 520, it is handled or routed based upon the class embodied in the packet. Should a packet be a valid packet suitable for routing it is embedded into a gateway specific UDP transport and dispatched to the appropriate application server. This handler subsequently acknowledges receipt and processes the data it has received. For example a 128 class or location report packet from a mobile is received by the router from the network. This packet is then packaged and sent via UDP to the configured address of a handler or gateway server 520. The gateway server 520 then processes the report recording the report as appropriate and acknowledging receipt of the report to the router. Currently, the gateway 520 uses the TCP socket based connection to a MOBITEX network. Specifics on the implementation of this interface are available from the carrier. Any interface wishing to transmit a packet to a mobile unit 110 may do so by embedding request into a UDP transport packet and sending it to the router associated with the gateway 520. This packet is acknowledged and subsequently sent to mobile 110.

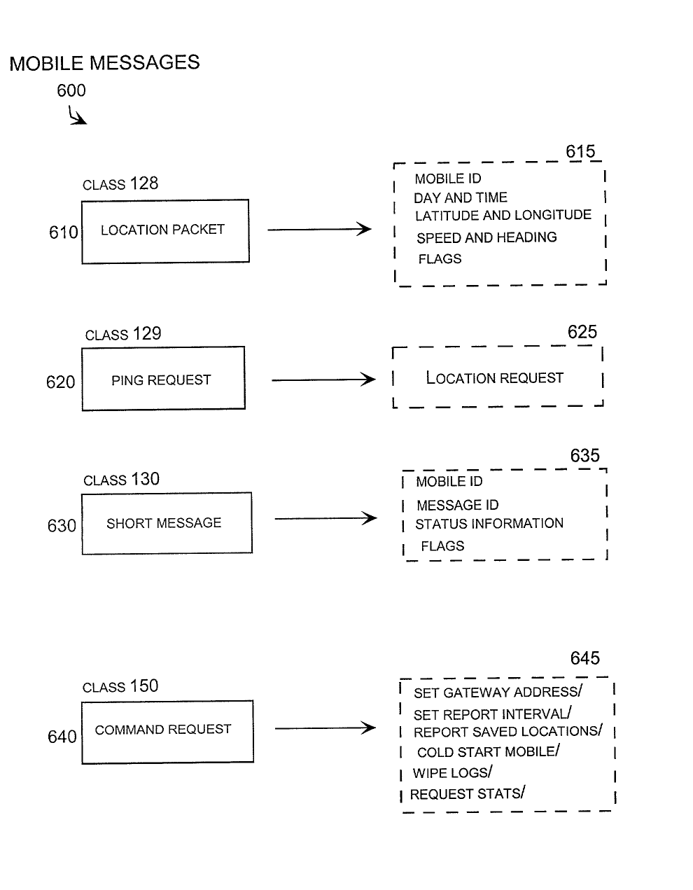

FIG. 6 illustrates common message formats from to and from the wireless network 120. All packets to and from the gateway are currently assigned one of four major classes. Class 128 is a location report from the mobile unit 110 to the WASP 140; Class 129 is an immediate location request; Class 130 is a short message; and Class 150 is a command request. Compression of data can be achieved by the use of bit stealing from values of reduced range and other known techniques.

As illustrated, Class 128 is a location packet 610 sent from the mobile unit 110 to the WASP 140. The location packet 610 provides location data 615. The location data 615 includes a mobile id, the day and time, latitude and longitude, speed and heading, as well as various flags. The flags includes an indication of whether the GPS had the current location data when the fix was made, an indication that a report could not transmit real-time due to lack of wireless coverage, an indication that the mobile unit was moving or moving above a set speed, whether a sensor is high or on, and other indications.

Class 129 is a ping request 620, which is an immediate location request 625. The mobile unit 110 will respond with a Class 128 location packet 610.

Class 130 is a short message 630. These short messages 630 includes message information 635. Short messages 630 can include mobile id, message id, status information of sensors, other flags, or other message data.

Class 150 is a command request 640. Command requests 640 include either behavior requests or remote commands 645. Behavior requests include a set gateway address, which tells the mobile unit 110 where to report. A set report interval informs the mobile unit 110 of how often to report with a Class 128 data packet 610 when moving. Another request is to report locations by saving the data in memory even when out of coverage. Additional behavior requests 645 include a request to report sensor transitions, set speeding threshold, and set serial port mode.

Class 150 also includes remote commands 645. These commands include cold start GPS, warm start GPS, cold start the mobile unit, and wipe mobile logs. Other remote commands 645 include request version of firmware, request profile which reports sensors above behavior values, and request status which returns information about GPS performance, radio performance, antenna status, and internal errors. If required, the response to a command request 640 can be a short message 630.

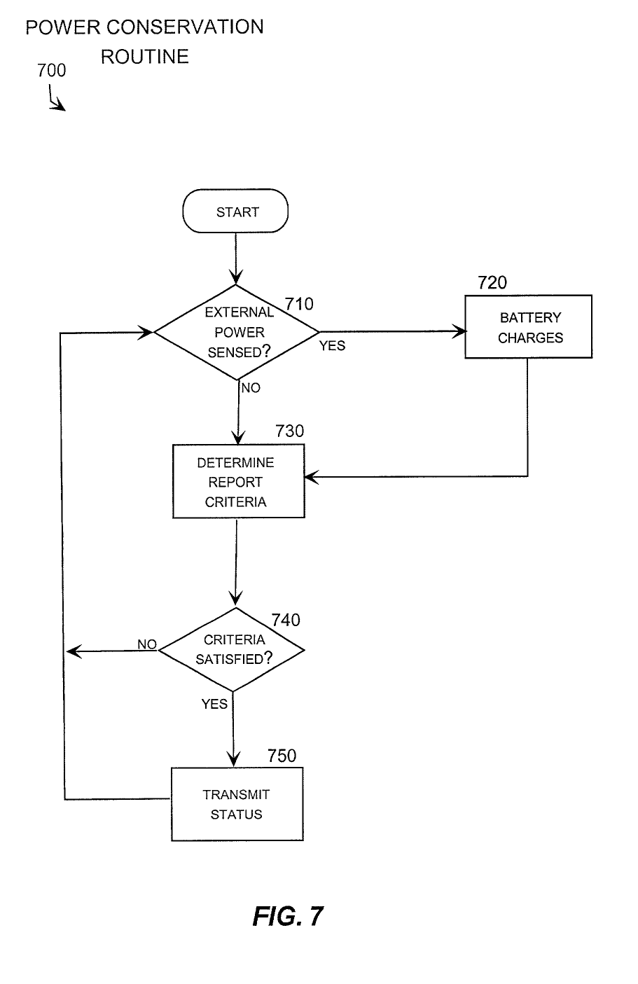

FIG. 7 discloses a power conservation routine 700. The processor 230 determines if external power 215 is available in order to determine a broadcast criteria.

The routine is initiated with a step 710. In step 710, the processor 230 determines whether external power 215 is available to the unit 110. If external power 215 is not available, the no branch of step 710 is followed to step 730, in which the broadcast criteria is determined. If external power 215 is available, the yes branch of step 710 is followed to step 720, in which the internal battery 210 is charged. Step 720 is followed by step 730.

In step 730, the processor 230 determines the broadcast criteria. Since transmission of status uses significant battery energy reserves, the broadcast criteria typically differs if external power 215 is available. Broadcast criteria is generally determined by a mobile unit 110 changing location a predetermined distance, a sensor status condition changed, or an alarm has been activated. When external power 215 is not available the conditions for broadcast are generally greater. For example, a broadcast criteria may specify a transmission to occur every 20 seconds while moving with external power available. However, a mobile unit 110 without external power 215 might have to move into a different preset zone. The broadcast criteria are stored in the memory 235 of the mobile unit 110.

Step 730 is followed by step 740, in which the processor 230 determines if the broadcast criteria has been satisfied. If the criteria has not been met, the no branch of step 740 is followed to step 710, in which the process again determines if external power is available. If the criteria has been met, the yes branch of step 740 is followed to step 750, in which the mobile unit 110 transmits its current status. Step 750 is followed by 710, in which the routine is re-executed.

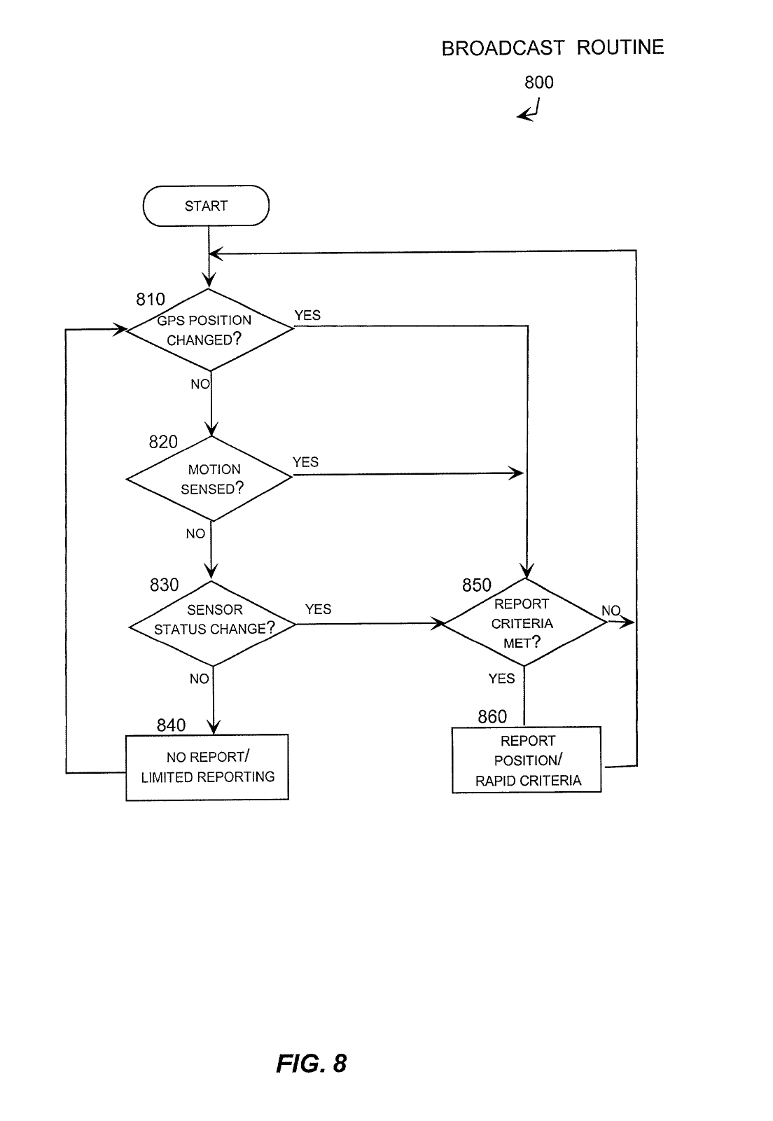

FIG. 8 discloses an intelligent broadcast routine 800. The processor 230 intelligently determines if a criteria has been met in order to determine if a new current status should be broadcast.

In step 810, the process 230 determines if the position of the mobile unit 110 has changed. If the position has changed, the yes branch of step 810 is followed to step 850, in which the processor determines if the change of location is sufficient to warrant a new status transmission. If the position has not changed, the no branch of step 810 is followed to step 820. For example, the criteria may specify to transmit its new location upon crossing into a new predefined zone.

In step 820, the processor determines if motion is sensed. Motion can be sensed from mechanical devices, a voltage signal, or electronic signals from the vehicle being monitored. If motion is not sensed, the no branch of 820 is followed to step 830. If motion is sensed, the yes branch of 820 is followed again to step 850, in which the processor 230 determines if the transmission criteria has been satisfied. For example, a status might be desired every three minutes when motion is sensed regardless of the position change.

In step 830, the process 230 determines if sensor status has changed. If a sensor 260 has changed status, the yes branch of step 830 is followed to step 860, in which the processor determines if the change status warrants a new status transmission. If the status has not changed, the no branch of step 830 is followed to step 840, in which the processor determines if a transmission should occur anyway. For example, a report might be desired every hour regardless of any change of status or location. Step 840 is followed by step 810, in which the routine is repeated.

Step 850 is followed by 860, if the processor has determined a new current status is to be reported. The radio modem 240 transmits the new status report to the wireless network 120. Step 860 is followed by step 810, in which the routine is repeated.

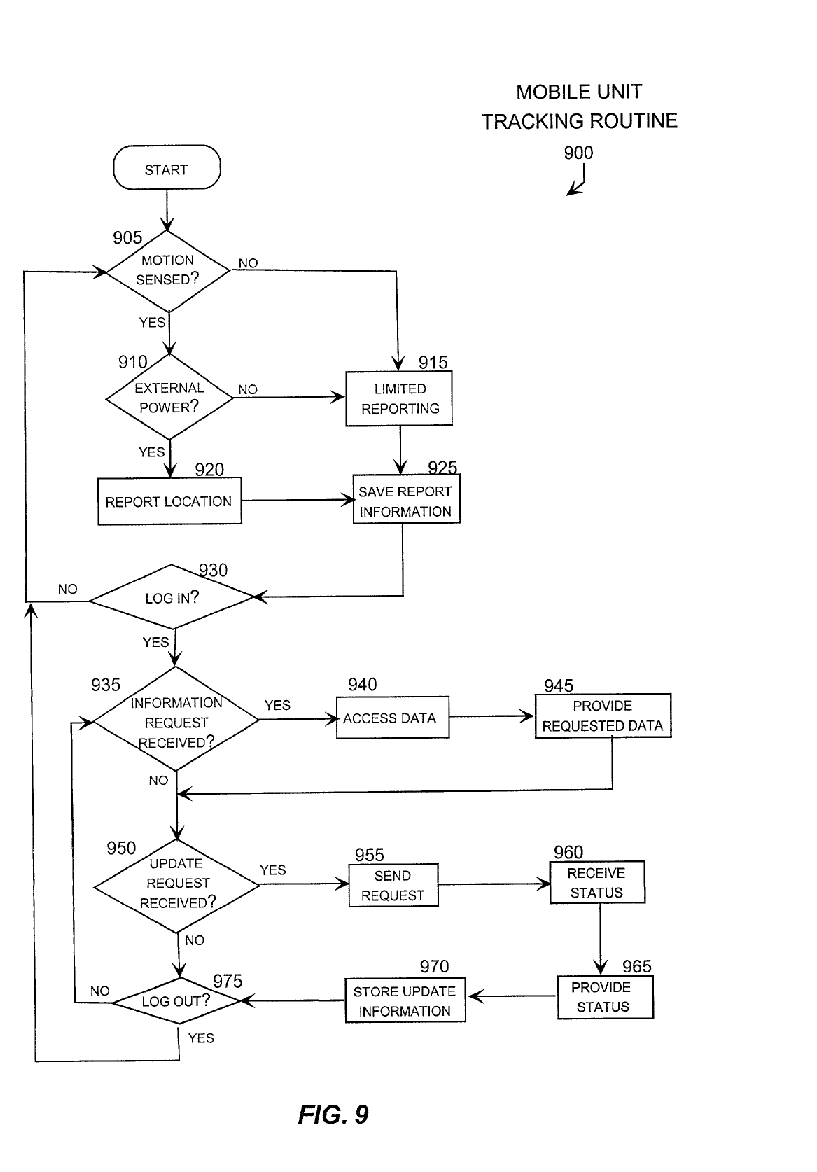

FIG. 9 discloses a mobile unit 110 tracking routine 900. In step 905, the processor 230 determines if motion is sensed. Motion can be sensed by change of GPS determined position, mechanical sensors, or electric signals from monitored the vehicle. If motion is sensed, the yes branch of step 905 is followed to step 910. If motion is not sensed, the no branch of step 905 is followed to step 915.

In step 910, the processor 230 determines if external power source 215 is sensed. If external power is sensed, the yes branch of step 910 is followed to step 920. If external power is not sensed, the no branch of step 910 is followed to step 915.

In step 915, the processor 230 determines if a limited reporting criteria has been satisfied. This criteria is generally a time based criteria and may not be depended on change of unit status. Step 915 is followed by step 925.

In step 920, the processor 230 determines if the criteria for reporting has been satisfied. The criteria for transmitting a new current status is based upon a change of condition of the mobile unit 110. This criteria can include such conditions as a specified change in geographic location, entering or exiting a predefined zone, the change in the status of a sensor, the presence of an alarm status, the presence of external battery power, a significant time change since the last transmission, or other predetermined criteria. Alarms can include the mobile unit 110 moving during a specified time period such as nighttime, exiting a predefined zone, speeding, or other conditions that warrant an immediate report. An alarm status update can be sent via email or other electronic ,fax, telephone, pager, or other electronic devices to the user 150. Other status information include sensor information. Sensor information can include a voltage indication, ignition status, mechanical indications of movement, electrical signals generated from the vehicle, or other signals that can be reported to the mobile unit 110. If the criteria has been achieved, a current status report is transmitted. Messages sent to and from the mobile unit 110 is described in greater detail in reference to FIG. 6. Step 920 is followed by step 925, in which the WASP 140 stores the current mobile unit status. In this manner the WASP 140 always has available the desired current and constant requests to the mobile unit are not necessary.

Step 925 is followed by step 930, in which the WASP 140 determines if a user 150 has logged into the system. If no user has log into the system, the no branch of step 930 is followed to step 905. If a user is determined to be logged in, the yes branch of step 930 is followed to step 935.

In step 935, the WASP 140 determines if an information request has been received. If no information request has been received, the no branch of step 935 is followed to step 950. If an information request has been received, the yes branch of step 935 is followed to step 940.

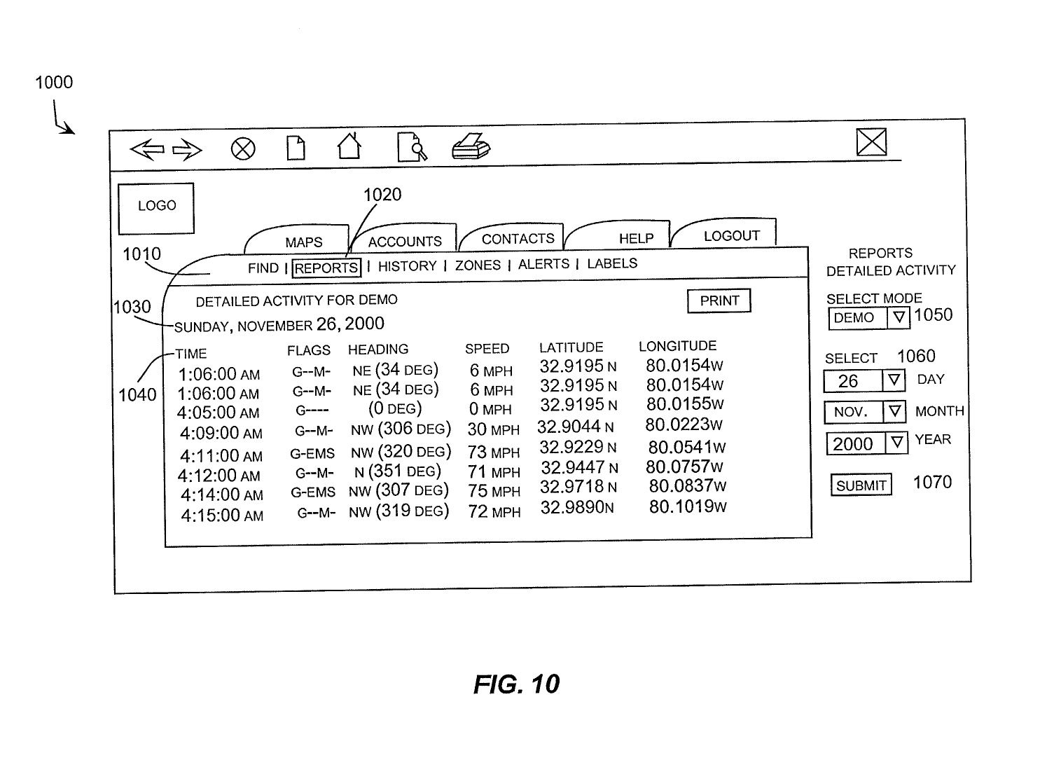

In step 940, the WASP accesses the stored status reports. The data storage is described in greater detail in reference to FIG. 5. Step 940 is followed by step 945, in which the WASP provides the mobile unit status. One status report generated by the WASP 140 is illustrated in FIG. 10. Step 945 is followed by step 950.

In step 950, the WASP 140 determines if the user 150 has requested an immediate update from the mobile unit 110. If the user has not requested an immediate update, the no branch of step 950 is followed to step 975. If the user has requested an immediate update, the yes branch of step 950 is followed to step 955.

In step 955, the WASP sends a ping request 620 to the mobile unit. The messages sent to and from the mobile unit 110 are described in greater detail in reference to FIG. 6. Step 955 is followed by step 960, in the WASP 140 receives the location information. In response to the ping request 620, the mobile unit 100 responds with a location packet 610. Step 960 is followed by step 965, in which the WASP 140 provides the current status to the user 150. Step 965 is followed by step 970, in which the WASP 140 stores the current status information. Step 970 is followed by step 975.

In step 975, the WASP 140 determines if the user has logged out. If the user has not logged out, the no branch of step 975 is followed to step 935. If the user has logged out, the yes branch is followed to step 905, in which the process is repeated.

Turning to FIG. 10, the screen shot of a wireless application service provider web page illustrates an Internet web page report 1000 displayed by the WASP 140 in response to a request from a user for a status report. The report 1000 displays the status information about the mobile unit 110 stored by WASP 140. Interactive web pages are well known in the art.

A topic selection line 1010 provides the user with the topics, which can be selected. A reports button 1020 is selected to generate a report for the mobile unit 110. A mode selection 1050 is a drop down box to select the mobile unit 110 desired. The select day, month, and year 1060 are three drop down boxes the enable the user 150 to specify the day, month and year for the report. After the date has been selected, the user activates the submit button 1070. In response to the activation of the submit button 1071, the WASP generates the requested report as shown. A date line 1030 displays the date for the report. A status information section 1040 displays the reported time, flags, heading, speed, latitude, and longitude for the mobile unit 110.

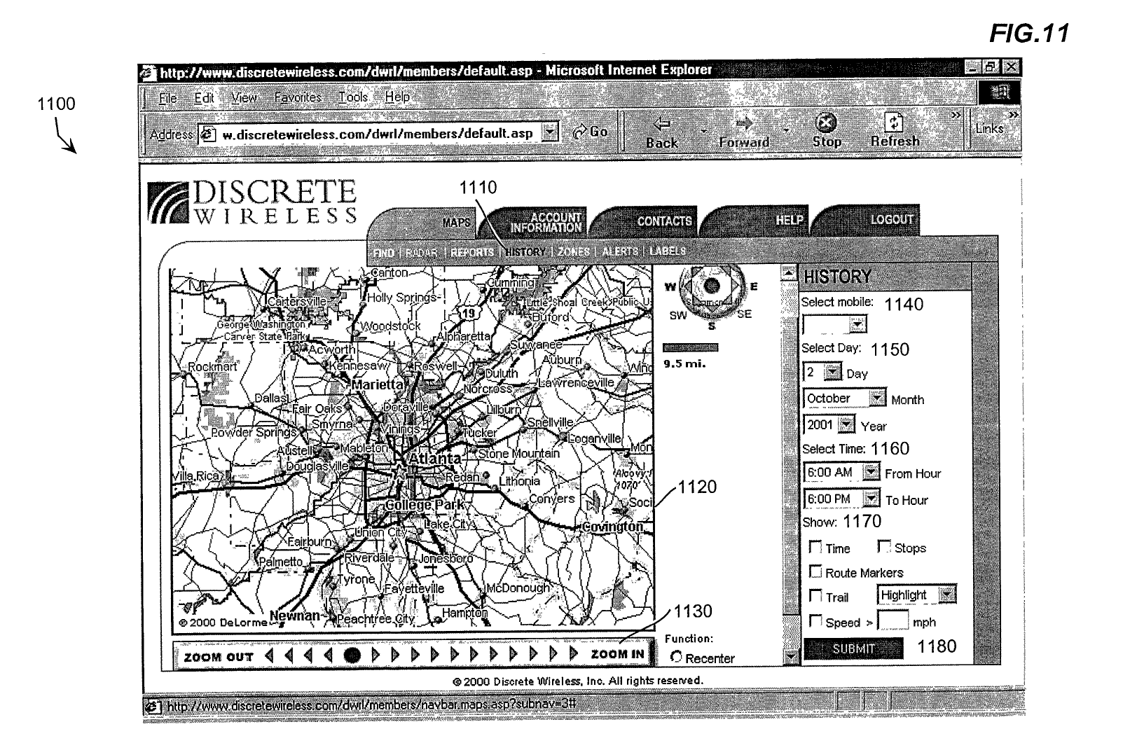

Turning to FIG. 11, the screen shot illustrates an Internet web page report 1100 displayed by the WASP 140 in response to a request from a user for a status report. The report 1100 displays the history information about the mobile unit 110 stored by WASP 140.

A mobile unit history is selected by the activation of the history button 1110. The user 150 selects the desired mobile unit 110 from the select mobile dropdown box 1140. The date and time is selected from select day dropdown boxes 1150 including day, month, and year drop down boxes. A select time drop down boxes 1160 allow selection of the start and end times for the history report. A show section 1170 allows the user 150 to select by checking the check box. Check boxes can select highlighting the trail, route markers, stops, and speed over a user inputted desired miles per hour. After making the above selections, the user activates the submit button 1180 to display the history map 1120. The user 150 can use the zoom line 1130 to zoom in or out to select the desired graphical area representation.

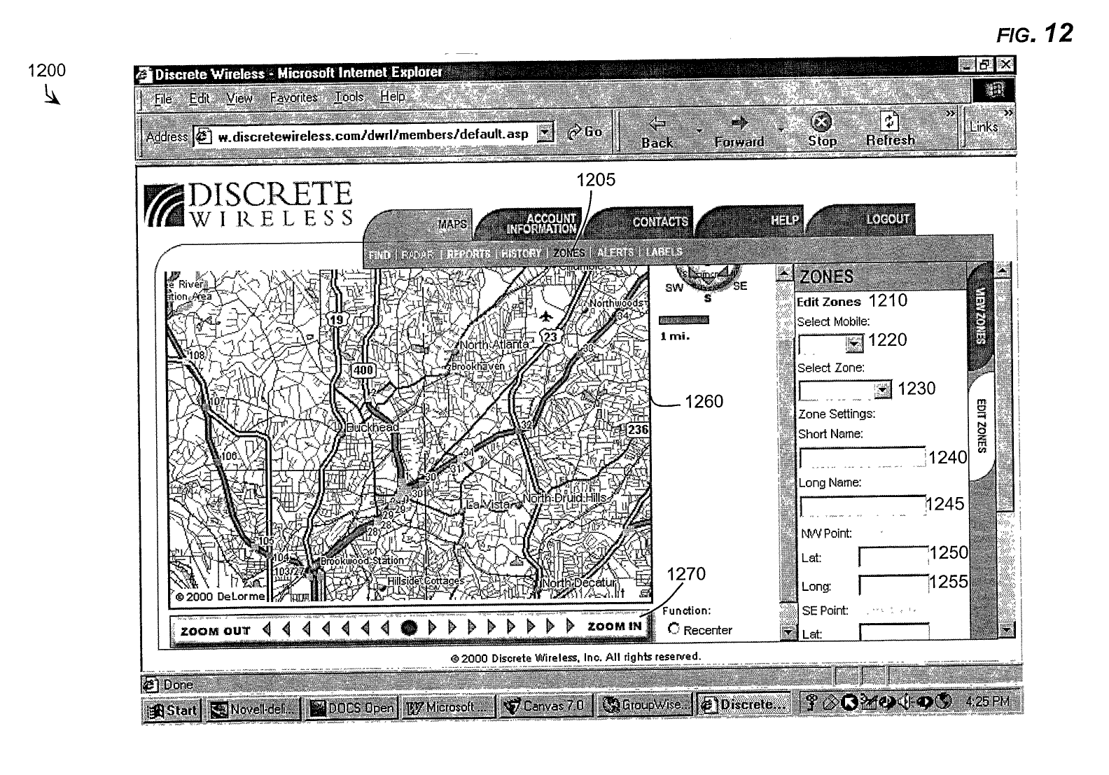

Turning to FIG. 12, the screen shot illustrates an Internet web page report 1100 displayed by the WASP 140 in response to a request from a user to edit zones. The edit 1200 displays the zone information stored by WASP 140.

A zone edit is selected by the activation of the zone button 1205. The user 150 edits the information from an edit zone area 1210. The mobile unit 110 desired to form the zone edit is selected from the select mobile 1220 dropdown box. A zone is selected from the select zone dropdown box 1230. The user 150 inputs a short name for the zone in the short name text field 1240. A long name is inputted in the long name text field 1245. The short zone name is the name that will appear of the map 1260 to identify the zone. The map 1260 also shows the zone boundaries. The zoom line 1270 allows the user 150 to select the graphical area to be depicted.

The user sets the boundary of the zone by the four set points of which one set point is associated with each corner of the zone. The northwest point is determined by the values entered in the associated number field for nw latitude number field 1250 and the nw longitude number field 1255.

In view of the foregoing, it will be appreciated that the invention provides a system for conservation of wireless resources. It should be understood that the foregoing relates only to the exemplary embodiments of the present invention, and that numerous changes may be made therein without departing from the spirit and scope of the invention as defined by the following claims. Accordingly, it is the claims set forth below, and not merely the foregoing illustration, which are intended to define the exclusive rights of the invention.

The invention claimed is:

1. A method for providing status information from a mobile unit, comprising the steps of:
comparing, at a mobile unit, current status data with the last broadcast status data;
determining a broadcast status criteria wherein the broadcast status criteria includes a plurality of predetermined criterions;
transmitting the current status databased upon the broadcast status criteria;
receiving the current status data at a host system;
storing the current status data;
receiving a request for the status information;
retrieving the current status data from storage on the host system; and
proving the status information based upon the stored current status data.

2. The method of claim 1, wherein the step of determining the broadcast criteria includes determining if an external power source is currently connected to the intelligent mobile unit.

3. The method of claim 1, wherein the step of determining the broadcast criteria includes determining if an external sensor has changed status.

4. The method of claim 1, wherein the step of determining the broadcast criteria includes determining if the mobile unit has entered or exited a predetermined geographical zone.

5. The method of claim 1, wherein the step of determining the broadcast criteria includes determining if the mobile unit has triggered a preset alarm.

6. The method of claim 5, wherein the step of determining if the mobile unit has triggered a predetermined alarm includes determining if the mobile unit has exceeded a predetermined speed limit.

7. The method of claim 5, wherein the step of determining if the mobile unit has triggered a predetermined alarm includes determining if the mobile unit has exited a geographically defined zone.

8. The method of claim 5, wherein the step of determining if the mobile unit has triggered a predetermined alarm includes determining if the mobile unit has moved during a predetermined time period.

9. A system for providing status information from a mobile unit, comprising:
an all-inclusive container with a connector for an external power source and at least one connector for external sensor signals;
an internal power supply chargeable by the external power source;
an internal global positioning receiver connected to the internal power supply;
an internal processor coupled to the global positioning receiver wherein the processor transmits current status data based upon a broadcast status criteria;
internal memory coupled to the processor wherein the memory stores the broadcast status criteria;
an internal radio modem coupled to the processor; and
an internal antenna coupled to the radio modem.

10. A system for providing status information from a mobile unit, comprising:
an all-inclusive container with a connector for an external power source;
an internal power supply chargeable by the external power source;
an internal global positioning receiver connected to the internal power supply;
an internal processor coupled to the global positioning receiver wherein the processor determines a broadcast criteria based upon if external power is available;
internal memory coupled to the processor wherein the memory stores the broadcast criteria;
an internal radio modem coupled to the processor; and
an internal antenna coupled to the radio modem.

11. A system for providing status information from an intelligent mobile unit, comprising:
an all-in-one box mobile unit comprising:
a container with an external power source connection and at least one external sensor signal connection comprising:
an internal power supply chargeable by the external power source;
an internal global positioning receiver connected to the internal power supply;
an internal processor coupled to the global positioning receiver wherein the processor transmits current status data based upon a broadcast status criteria;
internal memory coupled to the processor wherein the memory stores the broadcast status criteria;
an internal radio modem coupled to the processor; and
an internal antenna coupled to the radio modem;
a wireless network wherein the wireless network receives wireless data packets transmitted from the radio modem;
a host system that receives data packets from the wireless network and stores the data packet information on a storage mechanism;
a global computer network for delivering a status request to the host system wherein the global computer network delivers the status information based upon the stored data packet information.

12. A system for providing status information from a mobile unit, comprising:
a mobile unit containing a radio modem, a global position receiver, and a processor wherein the processor causes a transmission if a broadcast criteria has been satisfied, the broadcast criteria includes a plurality of criterions;
a wireless network wherein the wireless network receives wireless data packets transmitted from a radio modem within the mobile unit;
a global computer network for delivering a status request to a host system;
the host system that receives data packets from the wireless network, stores the data packet information on a storage mechanism, and provides the status information from the stored information at the host system.

13. A method for providing status information from a mobile unit, comprising the steps of:
comparing, at the mobile unit, current status data with last broadcast status data;
determining a broadcast criteria wherein the broadcast criteria includes a plurality of predetermined criterions of which one criterion is whether external power is available to the mobile unit;
transmitting the current status databased upon the broadcast status criteria;

14. The method of claim 13, wherein the step of determining the broadcast criteria includes determining if an external sensor has changed status.

15. The method of claim 13, wherein the step of determining the broadcast criteria includes determining if the mobile unit has entered or exited a predetermined geographical zone.

16. The method of claim 13, wherein the step of determining the broadcast criteria includes determining if the mobile unit has triggered a preset alarm.

17. The method of claim 13 wherein the step of determining if the mobile unit has triggered a predetermined alarm includes determining if the mobile unit has exceeded a predetermined speed limit.

18. The method of claim 13, wherein the step of determining if the mobile unit has triggered a predetermined alarm includes determining if the mobile unit has exited a geographically defined zone.

19. The method of claim 13, wherein the step of determining if the mobile unit has triggered a predetermined alarm includes determining if the mobile unit has moved during a predetermined time period.
